(19) United States
(12) Patent Application Publication
(10) Pub. No.: US 2014/0046732 A1
(43) Pub. Date: Feb. 13, 2014

(54) TECHNOLOGY ASSESSMENT SYSTEMS AND METHODS

(71) Applicant: TAEUS, Colorado Springs, CO (US)

(72) Inventors: Arthur Michael Nutter, Colorado Springs, CO (US); James Russell Adams, Colorado Springs, CO (US); James Walter Patton, Colorado Springs, CO (US); Jeffrey A. Pagano, Colorado Springs, CO (US); Glenn Wheeler, Colorado Springs, CO (US)

(73) Assignee: TAEUS, Colorado Springs, CO (US)

(21) Appl. No.: 13/967,172

(22) Filed: Aug. 14, 2013

Related U.S. Application Data
(63) Continuation of application No. 10/145,374, filed on May 14, 2002.
(60) Provisional application No. 60/291,090, filed on May 15, 2001.

(51) Int. Cl. G06Q 50/18; G06Q 40/06

(52) U.S. Cl. CPC G06Q 50/184; G06Q 40/06
USPC 705/7.35

(57) ABSTRACT

A intellectual property evaluation method includes the steps of receiving a plurality of input scores for each of a plurality of patents by a intellectual property management software program. The plurality of input scores are combined to form a scale value for each of the plurality of patents. The scale values are compared to determine a select group of patents. A plurality of additional information is received by the intellectual property management software program for each of the select group of patents.

### CROSS-REFERENCES TO RELATED APPLICATIONS

This application in a continuation of U.S. application Ser. No. 10/145,374, filed May 14, 2002, which claims priority based on the provisional patent application entitled “TAEUSWorks”, filed May 15, 2001, having Ser. No. 60/291,090 and assigned to the same assignee as the present application.

### FIELD OF THE INVENTION

The present invention relates generally to the field of licensing systems and more particularly to an intellectual property evaluation method and system.

### BACKGROUND OF THE INVENTION

Large companies often have numerous patents and other intellectual property that they have accumulated over the years. Commonly, a number of different attorneys and inventors have been involved in obtaining these patents and other intellectual property. As a result, the company often does not have any records on why the intellectual property was obtained or which product lines they cover. Each patent has maintenance fees and annuities that are required to be paid in order to keep the patent in force. These costs can be substantial for a large portfolio of patents. Thus it is common for such a company to want to determine which patents in their portfolio have value internally or may be licensed to other companies. One solution is that the present attorneys for the corporation are asked to determine which patents have licensing potential. This process may be performed internally, however the quality of the review is limited by the fact that the attorney has other pressing demands on his time. Alternatively, the company may hire consultants to evaluate the patents. However, consultants usually require a large fee to examine each patent and therefore it is cost prohibitive to sort through a large number patents. Another system uses citation analysis of patents or technical papers to determine which patents are most valuable. This method has proven to be very unreliable.

Thus there exists a need for a system and method that allows a company to determine the likelihood of obtaining a license for a large number of patents or other intellectual property in a cost effective manner.

### BRIEF DESCRIPTION OF THE DRAWINGS

FIG. 1 is a block diagram of a intellectual property evaluation system in accordance with one embodiment of the invention;

FIG. 2 is a block diagram of a intellectual property evaluation system in accordance with one embodiment of the invention;

FIG. 3 is a flow chart of the steps used in a intellectual property evaluation method in accordance with one embodiment of the invention;

FIG. 4 is a flow chart of the steps used in a intellectual property evaluation method in accordance with one embodiment of the invention;

FIG. 5 is a screen shot of a user manual used in a intellectual property evaluation system in accordance with one embodiment of the invention;

FIG. 6 is a screen shot of an input form used in a intellectual property evaluation system in accordance with one embodiment of the invention;

FIG. 7 is a screen shot of a level one evaluation of an intellectual property used in a intellectual property evaluation system in accordance with one embodiment of the invention;

FIG. 8 is a screen shot of an output screen used in a intellectual property evaluation system in accordance with one embodiment of the invention;

FIG. 9 is a screen shot of an input form used in a intellectual property evaluation system in accordance with one embodiment of the invention;

FIG. 10 is a screen shot of an input form used in a intellectual property evaluation system in accordance with one embodiment of the invention;

FIG. 11 is a screen shot of an output screen used in a intellectual property evaluation system in accordance with one embodiment of the invention;

FIG. 12 is a screen shot of a level two output screen used in a intellectual property evaluation system in accordance with one embodiment of the invention;

FIG. 13 is a screen shot of a level one output screen used in a intellectual property evaluation system in accordance with one embodiment of the invention; and

FIG. 14 is a screen shot of a potential licensee output screen used in a intellectual property evaluation system in accordance with one embodiment of the invention.

### DETAILED DESCRIPTION OF THE DRAWINGS

A intellectual property evaluation method includes the steps of receiving a plurality of input scores for each of a plurality of intellectual properties by a intellectual property management software program. The plurality of input scores are combined to form a scale value for each of the plurality of intellectual properties. The scale values are compared to determine a select group of intellectual properties. A plurality of additional information is received by the intellectual property management software program for each of the select group of intellectual properties. A definition is provided for each of the input scores and this allows experts to use the same definitions when evaluating intellectual properties. The scores are combined by the computer and this makes it easy to eliminate the intellectual properties that do not score in the upper 20% for instance. Using this system large groups of intellectual properties may be given a preliminary evaluation quickly and inexpensively. The additional information includes potential licensees and this provides a second level screening of a group of intellectual properties inexpensively. The system and method make it possible for a corporation to quickly screen a large portfolio of intellectual properties and determine which intellectual properties provide the most value. Note that intellectual property includes patents, trademarks, trade secrets and copyrights. Despite this patents are generally the most valuable intellectual property and most commonly used with this invention. As a result, the patent in the remainder of this document should be interpreted to mean “patent, trade secret or other intellectual property.”

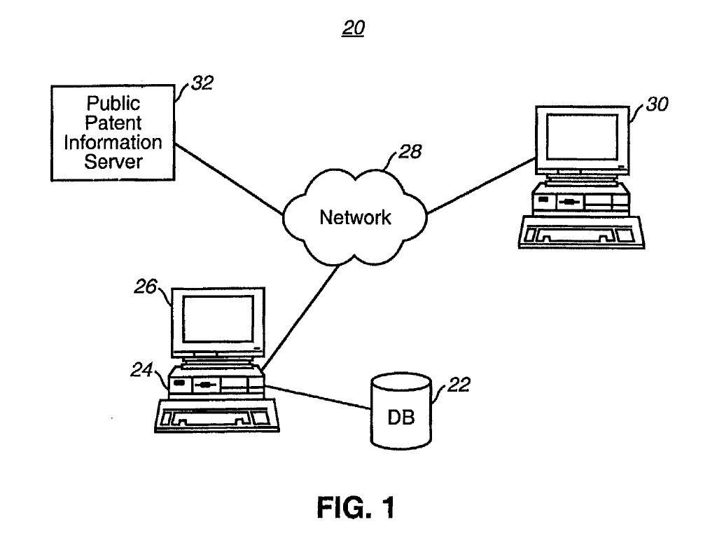

FIG. 1 is a block diagram of a intellectual property evaluation system 20 in accordance with one embodiment of the invention. The system 20 has a database 22 containing a plurality of patents (or information about patents). The database is connected to a computer 24 having a monitor 26. In one embodiment, the computer 24 is connected to a network 28. The network 28 is connected to a second computer 30 and a public patent information server 32, in one embodiment. Once a group of patents have been selected for evaluation, the computer 24 may contact the public patent information server 32 to obtain a plurality of basic patent information and potentially other, classification information. This other information may include the Derwent® technical classification.

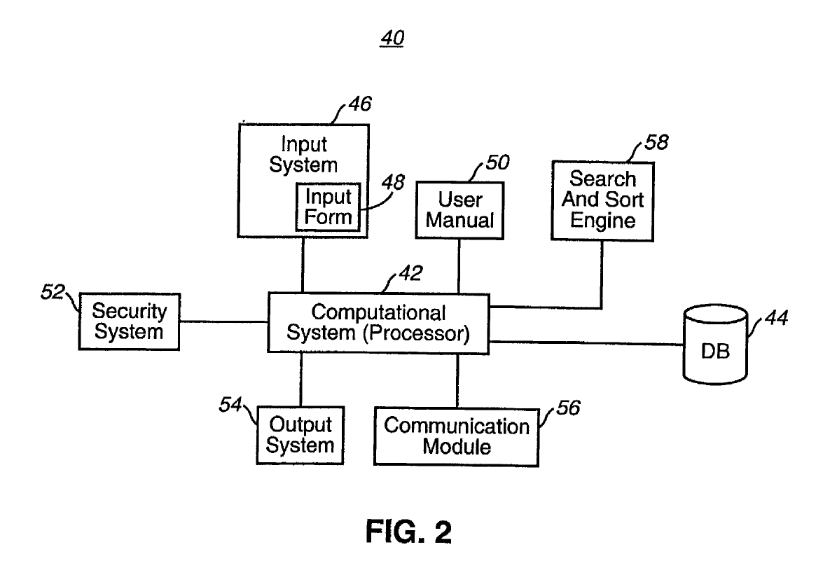

FIG. 2 is a block diagram of a intellectual property evaluation system 40 in accordance with one embodiment of the invention. The system 40 uses a computer to run a intellectual property management software. When the intellectual property management software is executed the computer has computational system (processor) 42 that numerically combines at least part of the plurality of evaluative information to form a scale factor for one of plurality of patents. A database 44 is coupled to the computational system 42 and contains a set of information on a plurality of patents. An input system 46 has an input form 48 capable of being displayed on a monitor. The input form 48 prompting a user to enter a plurality of evaluative information about one of the plurality of patents. A user manual 50 is coupled to the computational system 42. The user manual 50 is capable of being displayed on a monitor and contains criteria for the plurality of evaluative information. A security system 52 is coupled to the computational system 42. The security system 52 may require a password from a user before allowing them access to the system 40. An output system 54 is coupled to the computational system 42. The output system has an output form that may be displayed on a monitor. The output form displays a patent number and at least part of the evaluative information. A communication module 56 is coupled to the input system 46 and may be used to acquire public information about the plurality of patents. A search and sort engine 58 allows the system 40 to sort through the patents for selected criteria.

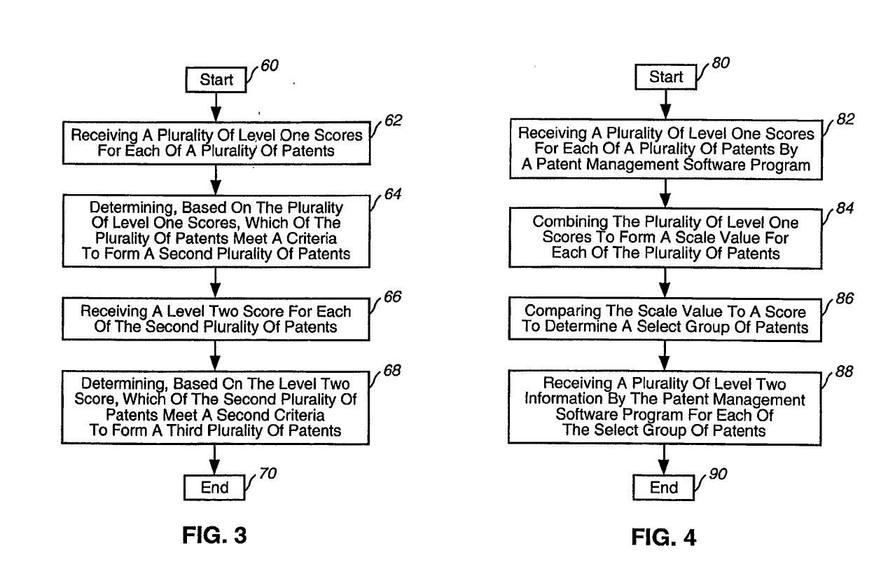

FIG. 3 is a flow chart of the steps used in a intellectual property evaluation method in accordance with one embodiment of the invention. The process starts, step 60, by receiving a plurality of input scores for each of a plurality of patents at step 62. Based on the plurality of input scores it is determined which of the plurality of patents meet a criteria to form a second plurality of patents at step 64. For instance, only those patents in the top 10% might meet the criteria to be part of the second group of patents. A level two score is received for each of the second plurality of patents at step 66. At step 68 it is determined which of the second plurality of patents meet a second criteria to form a third plurality of patents which ends the process at step 70. In one embodiment, potential licensees are determined for each of the second plurality of patents. This and other information is used to determine a level two score. Only those patents with the highest level two scores are selected for further investigation or effort.

In one embodiment, a plurality of public information is received for at least one of the third plurality of patents. The plurality of public information may include data sheets, technical specifications or sales literature. This information may provide the user with clues as to whether the potential licensee is using the patent.

In one embodiment a basic patent information for each of the plurality of patents is acquired. This may be acquired through a public patent database.

The plurality of input scores may be applied to at least one of the following licensing parameters: observability; possibility of prior art; future commercial use; difficulty of investigation; strength of claims; availability of alternatives and present commercial use. In one embodiment, an average of the input scores is determined. In another embodiment a weighted average of the input scores is determined.

FIG. 4 is a flow chart of the steps used in a intellectual property evaluation method in accordance with one embodiment of the invention. The process starts, step 80, by receiving a plurality of input scores for each of a plurality of patents by a intellectual property management software program at step 82. The plurality of input scores are combined to form a scale value for each of the plurality of patents at step 84. The scale value is compared to a score to determine a select group of patents at step 86. The score may be a threshold or may be set so that only a certain percentage of the plurality of patents are selected. At step 88 a plurality of additional information is received by the intellectual property management software which ends the process at step 90. The additional information may include a list of potential licensees (companies or products), a list of key claims of a patent, a key figure for each of the patents, a summary of the patent and a licensability rating. The licensability rating is a subjective evaluation based on all this previous information. The subjective evaluation is made by a group of experts in the technical area of the patent. In one embodiment a subset of the select group of patents is determined based on the plurality of additional information. Public information is then received about potential licensees related to the subset of the select group of patents. This information may include data sheets, sales information and other public information.

In one embodiment a technical category is received for each of the plurality of patents. The intellectual property management software may also display a plurality of licensing parameters to be scored. A weighting factor is determined for each of the plurality of licensing factors to be scored. An average or weighted average of the input scores may be determined to form a scale factor.

Note that while the process has been described with respect to a computer software program it is not limited to such a program. For instance, two or more experts in one embodiment might start by examining a patent and assigning a technology category associated with the technology employed or the market area to which the patent applies. Next the patent is reviewed and assigning a score value to each of a plurality of patent evaluation factors. The score values are combined from the plurality of patent evaluation factors to form an overall scale value for the patent. The overall scale value is used to determine whether to proceed with a more in-depth evaluation of the patent.

In one embodiment the patent is reviewed to identify the significant claims, a key figure(s), and a significant element(s) of the key figure(s) relative to the industry and the market area to which the patent applies. Next a list of potential licensees is developed by reviewing the patent against a plurality of licensability factors relative to the industry and market area to identify specific potential licensees who may have an interest in licensing the technology disclosed in the patent.

A licensability rating is assigned to the patent based on the evaluation of the plurality of licensability factors of the patent relative to the industry and market after considering all the licensability factors. A market research of the list of potential licensees is performed against a plurality of market factors including, but not limited to: total available market for the product(s) to which the patent applies, individual company sales of products to which the patent applies. A product documentation is reviewed relative to the patent's claims to determine the likelihood of use of the technology by a specific product. A licensing priority code is assigned to each potential licensee on the list of potential licensees based on the market factors, and the likelihood of use. A strength of a patent portfolio for each potential licensee on the list of potential licensees is identified relative to a patent holder's products. A second licensing priority code is assigned to each potential licensee on the list of potential licensees based on the market factors, the likelihood of use, and the strength of the patent portfolio. A weighting factor is assigned for each of the plurality of patent evaluation factors.

In one embodiment, a plurality of patents are examined and assigning a technology categories associated with the market area to which the patent applies. Each of the plurality of patents are reviewed and assigning a score value to each of a plurality of patent evaluation factors. The score values from the plurality of patent evaluation factors are combined to form an overall scale value for each of the plurality of patents. The overall scale value for each of the plurality of patents is used to rank order each of the plurality of patents relative to the other patents in the portfolio, either collectively or within each technology category, and to determine a subset of the plurality of patents to be subjected to a more in-depth evaluation.

In one embodiment, each of the subset of the plurality of patents is reviewed to identify a significant claim, a key figure, and a significant element of the key figure relative to the technology, industry and market area to which the patent applies. A list of potential licensees is developed for each of the subset of the plurality of patents by reviewing each patent against a plurality of licensability factors relative to the industry and market area to identify a potential licensee who may have an interest in licensing the technology disclosed in the patent. A licensability rating is assigned to each of the subset of the plurality of patents based on an evaluation of the licensability factors of the patent relative to the industry and market after considering all the licensability factors.

In one embodiment, the licensability rating is combined for the subset of the plurality of patents associated with each potential licensee of the list of potential licensees to determine a potential licensee rating.

In one embodiment, a market research is performed of a selected set of potential licensees against a plurality of market factors, including, but not limited to: total available market for the product(s) to which the patent applies, individual company sales of products to which the patent applies. A specific product documentation is reviewed from the selected set of potential licensees relative to the patent claim to determine the likelihood of use of the technology by a specific product. A licensing priority code is assigned to each of the selected set of potential licensees based on the plurality of market factors, and the likelihood of use. The licensing priority code is combined with the potential licensee rating to provide a licensing priority factor for prioritizing the potential licensees. A strength of each of a potential licensees' patent portfolio is identified relative to a patent holder's products. A licensing priority code is determined for each potential licensee based on at least the market factors, the likelihood of use, and a strength of the potential licensees' patent portfolio potential licensees' patent portfolio strength. The licensing priority code is combined with the potential licensee rating to provide a licensing priority factor for prioritizing the potential licensees. In one embodiment, a weighting factor is assigned for each of the plurality of patent evaluation factors.

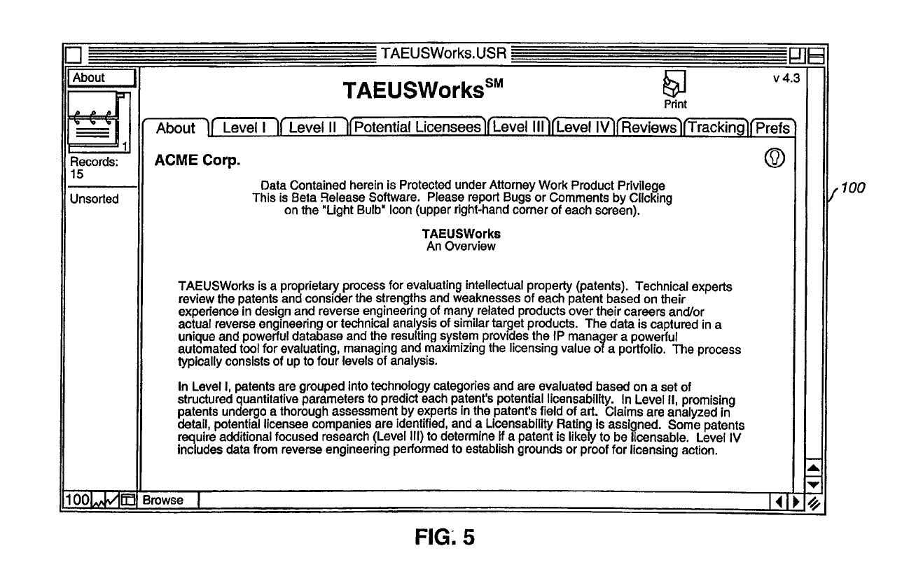

FIG. 5 is a screen shot 100 of a user manual used in a intellectual property evaluation system in accordance with one embodiment of the invention. The user manual explains the intellectual property evaluation process and how the software is used as part of this process.

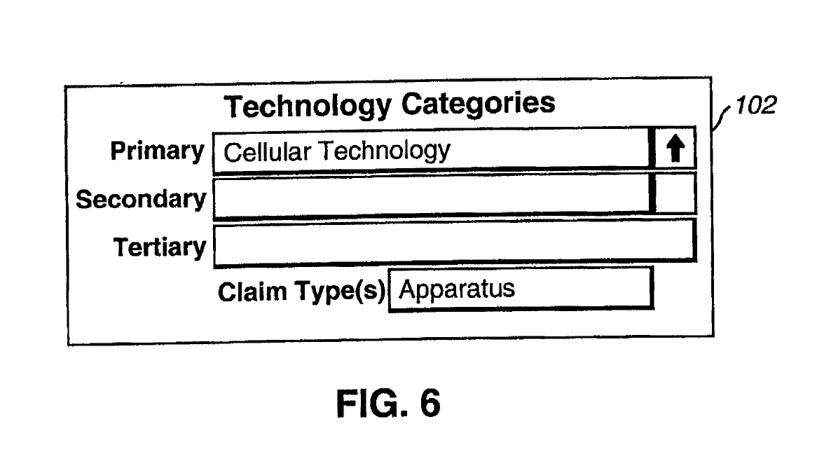

FIG. 6 is a screen shot of an input form 102 used in a intellectual property evaluation system in accordance with one embodiment of the invention. This input form 102 request that the user enter a technology categor(ies) for a patent. This information is helpful to group patents and decide which companies might want to license the patent.

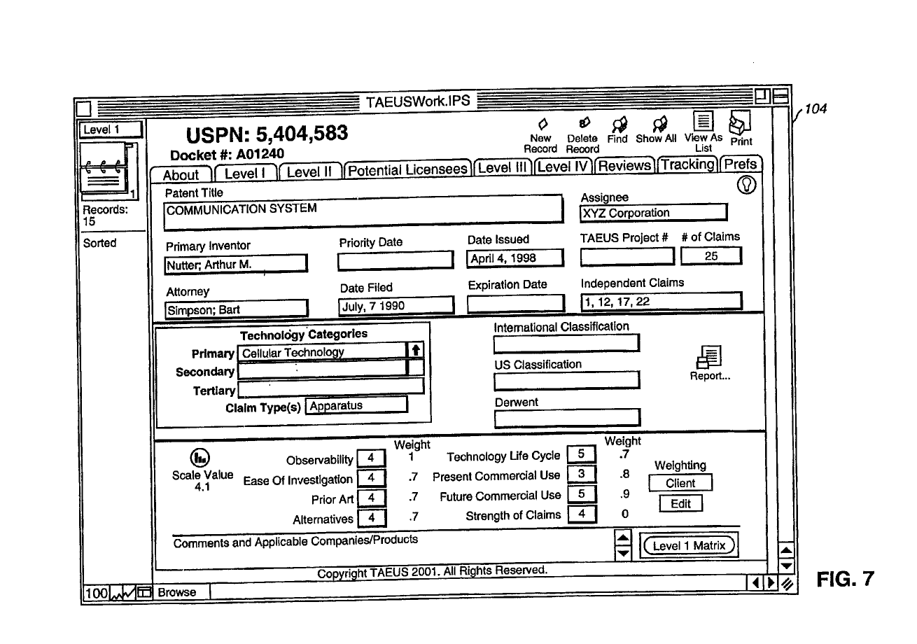

FIG. 7 is a screen shot 104 of a level one evaluation of a patent used in a intellectual property evaluation system in accordance with one embodiment of the invention. The screen 104 contains fields for initial patent evaluation data, as well as general information for each patent.

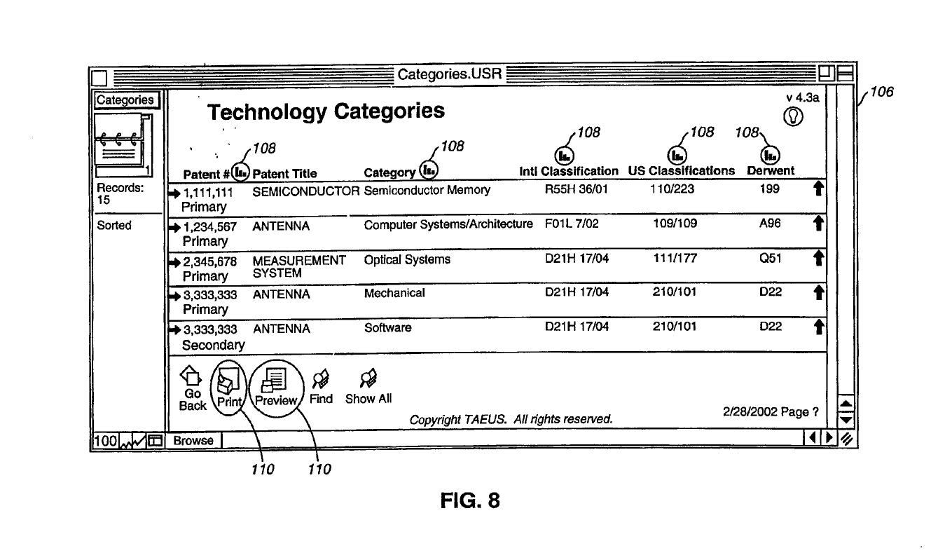

FIG. 8 is a screen shot 106 of an output screen used in a intellectual property evaluation system in accordance with one embodiment of the invention. The output screen shows a list of patents and the technology categories they fall within. A number sort icons 108 are shown on top of the screen. Other functions 110, such as print, are provided at the lower portion of the screen 106.

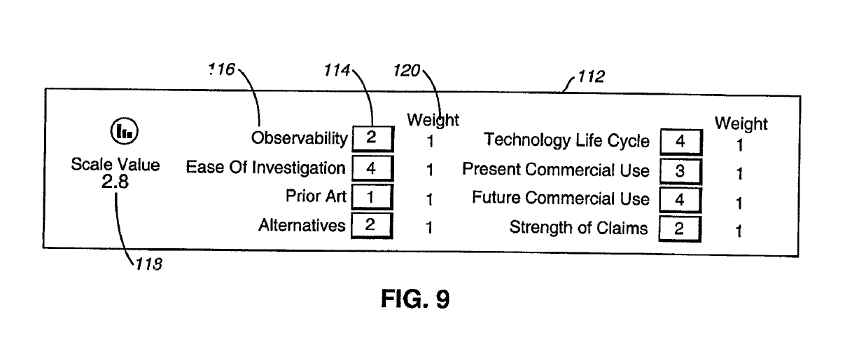

FIG. 9 is a screen shot 112 of an input form used in a intellectual property evaluation system in accordance with one embodiment of the invention. The input screen prompts the user to enter an input score 114 of one through five for each input parameter 116. A scale value 118 is shown. The scale value (overall scale value) is the average (weighted average) of the input scores. Note that a weighting value 120 is shown next to each input score 114. The input parameters include an observability rating. This measures how easy it is to observe the intellectual property technology being used. The next parameter, ease of investigating, measures how easy it is to prove that another company is using the patented technology. The next parameter, prior art, measures how likely there is to be prior art that limits the patent. The next parameter, alternatives, measures how easy it is to use an alternative technology. The next parameter, technology lifecycle, measures whether the technology is obsolete or embryonic. The next parameter, present commercial use, measures the likelihood of present use. The next parameter, future commercial use, measures the likelihood of use in the future. The last parameter, strength of claims, measures whether the claims are broad. Other parameters may be used and some of these parameters may be deleted to suit a particularly user's goals. In addition, the weighting factors can also be changed to suit a particularly user's goals.

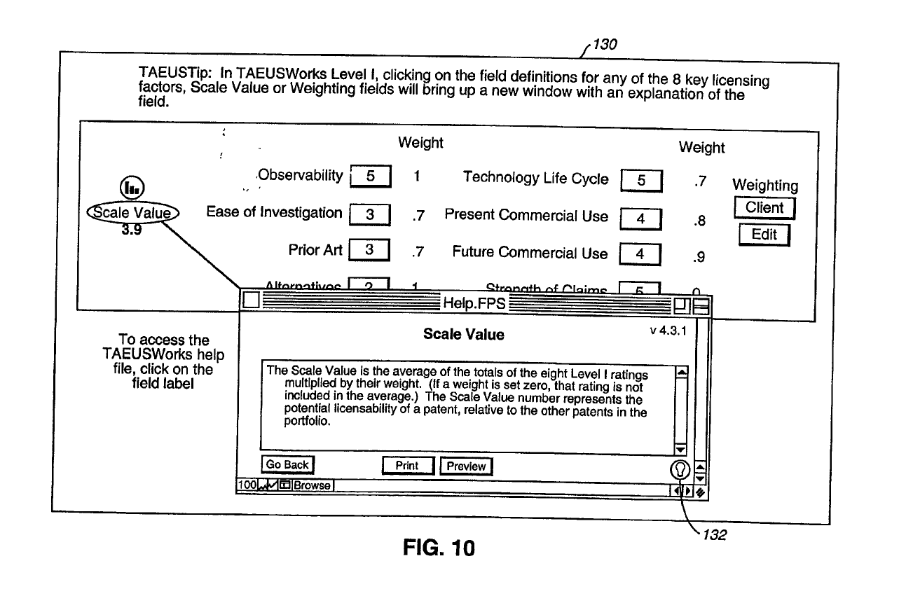

FIG. 10 is a screen shot 130 of an input form used in a intellectual property evaluation system in accordance with one embodiment of the invention. The screen shot 130 shows how a pop screen 132 provides the user with information on the items on the screen.

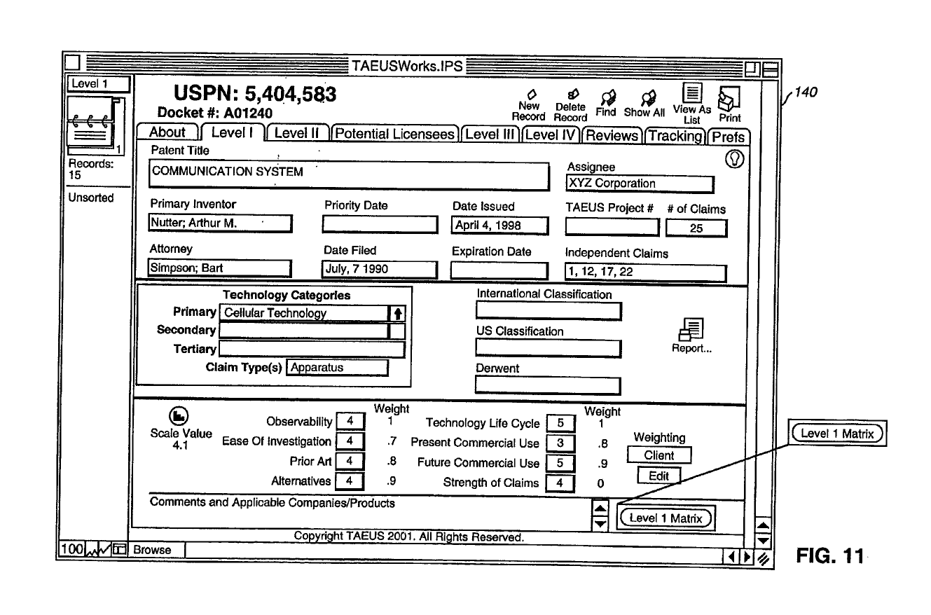

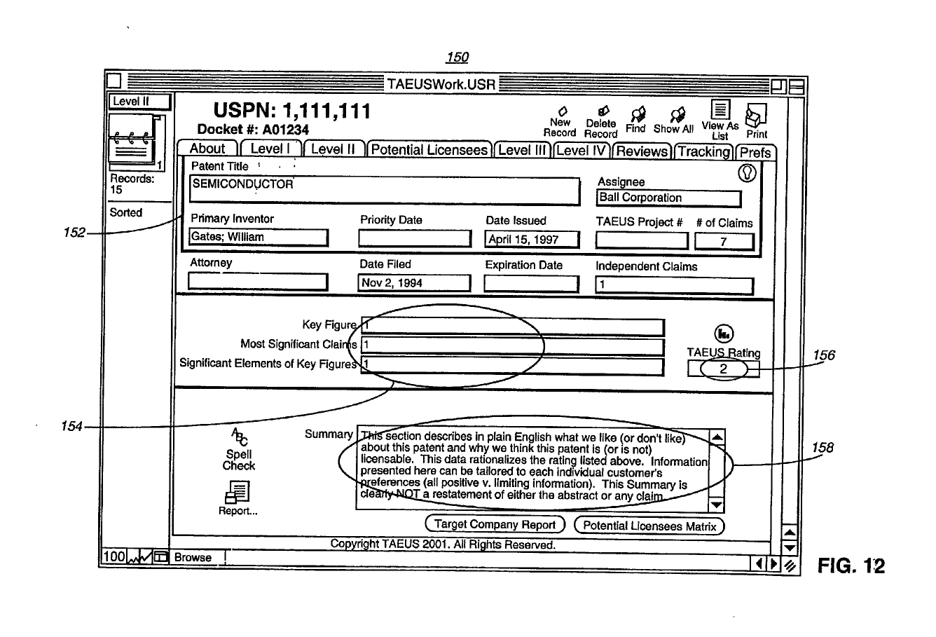

FIG. 11 is a screen shot 140 of an output screen used in a intellectual property evaluation system in accordance with one embodiment of the invention. This screen provides a summary of the initial (level one) input information about a patent.

FIG. 12 is a screen shot 150 of a level two output screen used in a intellectual property evaluation system in accordance with one embodiment of the invention. This output screen shows the title of the patent 152, the key claims and key FIG. 154, a licensability rating (based on level two and level one information) 156 and a summary 158. Note the licensability rating is a subjective evaluation by an expert in one embodiment.

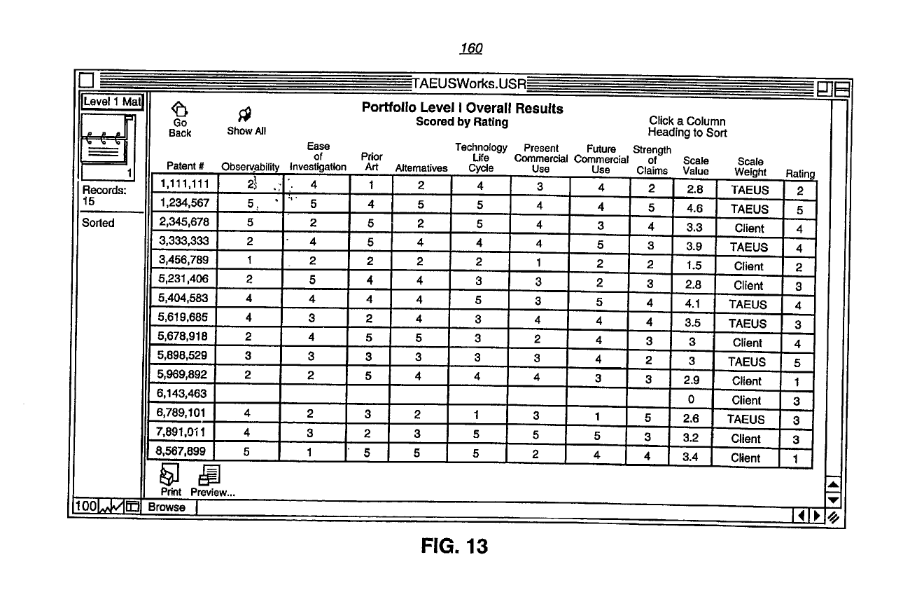

FIG. 13 is a screen shot 160 of a level one output screen used in a intellectual property evaluation system in accordance with one embodiment of the invention. This screen shows the patents reviewed and their input scores for each of the input parameters.

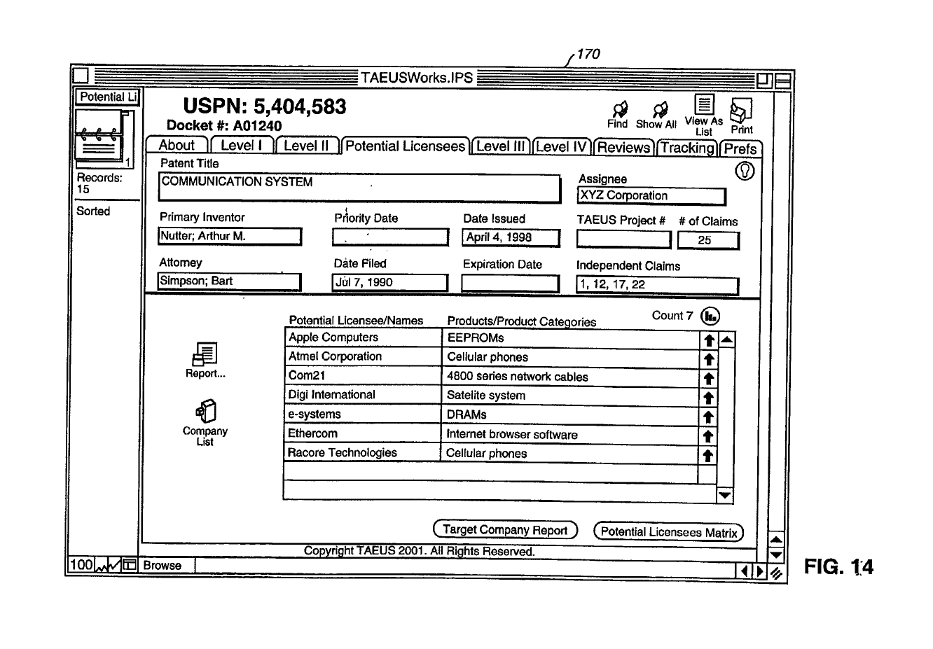

FIG. 14 is a screen shot 170 of a potential licensee output screen used in a intellectual property evaluation system in accordance with one embodiment of the invention. The screen lists potential licensees and the products that might use the patented technology.

Thus there has been described a system and method for evaluating patents. The system quickly and easily reduces the number of patents required to be studied. This makes it practical to review a large portfolio of patents.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1-48. (canceled)

49. A non-transitory machine-readable storage media having a set of instructions, the instructions, when executed by at least one machine, cause the at least one machine to:
produce a display that elicits entry of a plurality of scores for a plurality of licensing factors that relate to various aspects of a patented technology covered by a patent;
receive inputted scores;
calculate a weighted average of the plurality of scores to get a scale value;
receive market research information comprising a list of potential licensees of the patent identified by one or more experts; and
produce a display showing an overall licensing score for the patented technology, wherein the overall licensing score is determined based on an evaluation of the scale value and the market research information.

50. The machine-readable storage media of claim 49, wherein the licensing factors comprise one or more of: a measurement of how easy it is to observe the patented technology being used, a measurement of how easy it is to prove that another company is using the patented technology, an availability of alternative technologies, a measurement of whether the patented technology is obsolete or embryonic; a measurement of a likelihood that there is prior art that limits the patented technology, a measurement of the breadth of claims of the patented technology, a measurement of a likelihood of present commercial use, and a measurement of a likelihood of future commercial use.

51. The machine-readable storage media of claim 49, wherein the instructions are further configured to cause the at least one machine to produce a display showing at least one of: a title of the patent, a patent number of the patent, the overall licensability score, a key figure of the patent, a key claim of the patent, and a summary of the patent.

52. The machine-readable storage media of claim 51, wherein the summary comprises both positive and limiting information relating to a licensability of the patented technology.

53. The machine-readable storage media of claim 49, wherein the instructions are further configured to cause the at least one machine to produce a display to request entry of one or more technology categories for the patented technology.

54. The machine-readable storage media of claim 49, wherein the market research information is based on at least one of: total available market for one or more products to which the patented technology applies and individual company sales of the one or more products to which the patented technology applies.

55. The machine-readable storage media of claim 49, wherein the instructions are further configured to cause the at least one machine to produce a display showing the list of potential licensees, wherein the potential licensees comprise companies that may be interested in licensing the patented technology based on one or more technology categories and products of the companies that relate to the patented technology.

56. The machine-readable storage media of claim 49, wherein the instructions are further configured to cause the at least one machine to produce a display showing a plurality of patents and scores for each of the plurality of patents.

57. A system for assessment of technology comprising:
a display; and
a processor, the processor being communicatively coupled with the display and operable to:
produce an image on the display that elicits entry of a plurality of scores for a plurality of licensing factors that relate to various aspects of a patented technology covered by a patent;
receive inputted scores;
calculate a weighted average of the plurality of scores to get a scale value;
receive market research information comprising a list of potential licensees of the patent identified by one or more experts;
produce an image on the display showing an overall licensing score for the patented technology, wherein the overall licensing score is determined based on an evaluation of the scale value and the market research information;
produce an image on the display showing at least one of: a title of the patent, a patent number of the patent, the overall licensing score, a key figure of the patent, a key claim of the patent, and a summary of the patent; and
produce an image on the display to request entry of one or more technology categories.

58. The system for assessment of technology according to claim 57, wherein the processor is further operable to produce an image on the display showing the list of potential licensees, wherein the potential licensees comprise companies that may be interested in licensing the patented technology based on the one or more technology categories and products of the companies that relate to the patented technology.

59. The system for assessment of technology according to claim 57, wherein the licensing factors comprise one or more of: a measurement of how easy it is to observe the patented technology being used, a measurement of how easy it is to prove that another company is using the patented technology, an availability of alternative technologies, a measurement of whether the patented technology is obsolete or embryonic; a measurement of a likelihood that there is prior art that limits the patented technology, a measurement of the breadth of claims of the patented technology, a measurement of a likelihood of present commercial use, and a measurement of a likelihood of future commercial use.

60. The system for assessment of technology according to claim 57, wherein the processor is further operable to produce an image on the display comprising a plurality of patents and scale values for each of the plurality of patents.

61. The method according to claim 57, wherein the market research information is based on at least one of: total available market for one or more products to which the patented technology applies and individual company sales of the one or more products to which the patented technology applies.

62. The system for assessment of technology according to claim 57, wherein the summary comprises both positive and limiting information relating to a licensability of the patented technology.

63. A method for assessing technology, the method comprising:
producing by a computer a display that elicits entry of a plurality of scores for a plurality of licensing factors that relate to various aspects of a patented technology covered by a patent;
receiving inputted scores;
calculating a weighted average of the plurality of scores to get a scale value;
receiving market research information comprising a list of potential licensees of the patent identified by one or more experts;
producing by the computer a display showing an overall licensing score for the patented technology, wherein the overall licensing score is determined based on an evaluation of the scale value and the market research information;
producing by the computer a display to request entry of one or more technology categories; and
producing by the computer a display showing the list of potential licensees, wherein the potential licensees comprise companies that may be interested in licensing the patented technology based on the one or more technology categories and products of the companies that relate to the patented technology.

64. The method according to claim 63, wherein the method further comprises producing a display showing at least one of: a title of the patent, a patent number of the patent, the overall licensing score, a key figure of the patent, a key claim of the patent, and a summary of the patent.

65. The method according to claim 63, wherein the summary comprises both positive and limiting information relating to a licensability of the patented technology.

66. The method according to claim 65, wherein the licensing factors comprise one or more of: a measurement of how easy it is to observe the patented technology being used, a measurement of how easy it is to prove that another company is using the patented technology, an availability of alternative technologies, a measurement of whether the patented technology is obsolete or embryonic; a measurement of a likelihood that there is prior art that limits the patented technology, a measurement of the breadth of claims of the patented technology, a measurement of a likelihood of present commercial use, and a measurement of a likelihood of future commercial use.

67. The method according to claim 63, wherein the method further comprises producing a display showing a plurality of patents and scores for each of the plurality of patents.

68. The method according to claim 63, wherein the one or more technology categories comprise a primary technology category, a secondary technology category, and a tertiary technology category.
